(19) United States
(12) Patent Application Publication
(10) Pub. No.: US 2012/0151717 A1
(43) Pub. Date: Jun. 21, 2012

(54) Apparatus and Method for Manufacturing a Beam

(75) Inventor: Douglas Allen Zoller, Bay Village, OH (US)

(73) Assignee: The American Tank & Fabricating Company, Cleveland, OH (US)

(21) Appl. No.: 13/325,214

(22) Filed: Dec. 14, 2011

Related U.S. Application Data
(60) Provisional application No. 61/423,358, filed on Dec. 15, 2010.

(51) Int. Cl. F16B 2/06; B23P 17/00

(52) U.S. Cl. 24/335; 29/897.35

(57) ABSTRACT

Provided is an apparatus comprising a tensioner, first clamp, first slide, second clamp, and second slide. A tensioner may be adapted to apply a tensile force along a first dimension, may comprise a first end and a second end movable with respect to one another, and may be adapted to apply a clamping force therebetween. A first slide may be adapted to secure the first clamp such that the first clamp is substantially free to move in a second dimension and may comprise a first end and a second end movable with respect to one another. A second clamp may be adapted to apply a clamping force between the first end and the second end and may be adapted to secure the second clamp, such that the second clamp is substantially free to move in the second dimension.

### TECHNICAL FIELD

Certain embodiments disclosed herein relate generally to fabrication of structural beams. More specifically, certain embodiment disclosed herein related generally to securing together the components of structural beams.

### BACKGROUND

Structural beams come in a wide variety of forms. The form of a structural beam may be determined by a set of variables that may comprise the geometry of the beam and the material of the beam.

One method of fabrication of structural beams comprises welding together two or more components of structural beams. In some embodiments, the components of the structural beam may comprise a web and a flange. In some embodiments, the web and the flange may be joined together by a joining operation to form a beam.

Many materials undergo dimensional change in response to temperature change. Dimensional change in response to temperature change may also be known as thermal strain. Without limitation, some materials expand when heated and contract when cooled.

A joining operation may comprise heating of one or more components to be joined. In some joining processes, the component may have its temperatures changed dramatically from the temperature to which the component will be subjected to during normal use. In some joining processes one component or one part of the component may be heated or have its temperature changed unevenly with respect to other parts of the same component or other components. Uneven heating can result in uneven thermal strain or thermal distortion.

In some operations, uneven thermal strain of a component may result in unacceptable product quality, or may result in additional undesirable manufacturing cost or time. In some joining operations thermal strain of a component during or after joining operations may not be negligible and may result in unacceptable product quality, or may result in additional undesirable manufacturing cost or time. In some operations, uneven thermal strain or thermal distortion may result in unacceptable bending or warpage of the finished beam.

It remains desirable to provide methods of securing the components of beams so that uneven strain or distortion of the beam during or after joining operations, does not result in unacceptable product quality and does not result undesirable additional manufacturing cost or time.

### SUMMARY

Provided is an apparatus comprising a tensioner, a first clamp, a first slide, a second clamp, and a second slide. A tensioner may be adapted to apply a tensile force along a first dimension. A first clamp may comprise a first end and a second end with at least one of the ends movable with respect to the other. A first clamp may be adapted to apply a clamping force between the first end and the second end. A first slide may be adapted to secure the first clamp such that the first clamp may be substantially free to move in a second dimension. A second clamp may comprise a first end and a second end with at least one of the ends movable with respect to the other. A second clamp may be adapted to apply a clamping force between the first end and the second end. A second slide may be adapted to secure the second clamp, such that the second clamp may be substantially free to move in the second dimension.

Further provided is an apparatus that may comprise a tensioner, a first clamp, a first slide, a second clamp, and a second slide. A tensioner may be adapted to apply a tensile force along a first dimension to an associated first beam component. A first clamp may be adapted to compressively engage an associated second beam component with the associated first beam component. A first slide may be adapted to secure the first clamp, such that the first clamp may be substantially free to move in a second dimension. A second clamp may be adapted to compressively engage the associated second beam component with the associated first beam component. A second slide may adapted to secure the second clamp, such that the second clamp may be substantially free to move in the second dimension.

Further provided is a method comprising applying a tensile force along a first dimension to a first beam component, applying a compressive force with a first clamp to compressively engage at least part of a second beam component with at least part of the first beam component, and applying a compressive force with a second clamp to compressively engage at least part of the second beam component with at least part of the first beam component. The first clamp may be to move in a second dimension. The first compressive force may be applied in a direction substantially parallel to the second dimension. The second clamp may be free to move in a second dimension. The second compressive force may be applied in a direction substantially parallel to the second dimension.

### BRIEF DESCRIPTION OF THE DRAWINGS

FIG. 1 is a cross-sectional view of a beam;

FIG. 2 is a view of a fixture;

FIG. 3 is a close up view of a component of a fixture;

FIG. 4 is a view of hydraulic machinery;

FIG. 5 is a close up view of a component of a fixture;

FIG. 6 is a close up view of a component of a fixture;

FIG. 7 is a close up view of a component of a fixture;

FIG. 8 is a side view of a fixture; and

FIG. 9 is a close up view of a component of a fixture.

### DETAILED DESCRIPTION

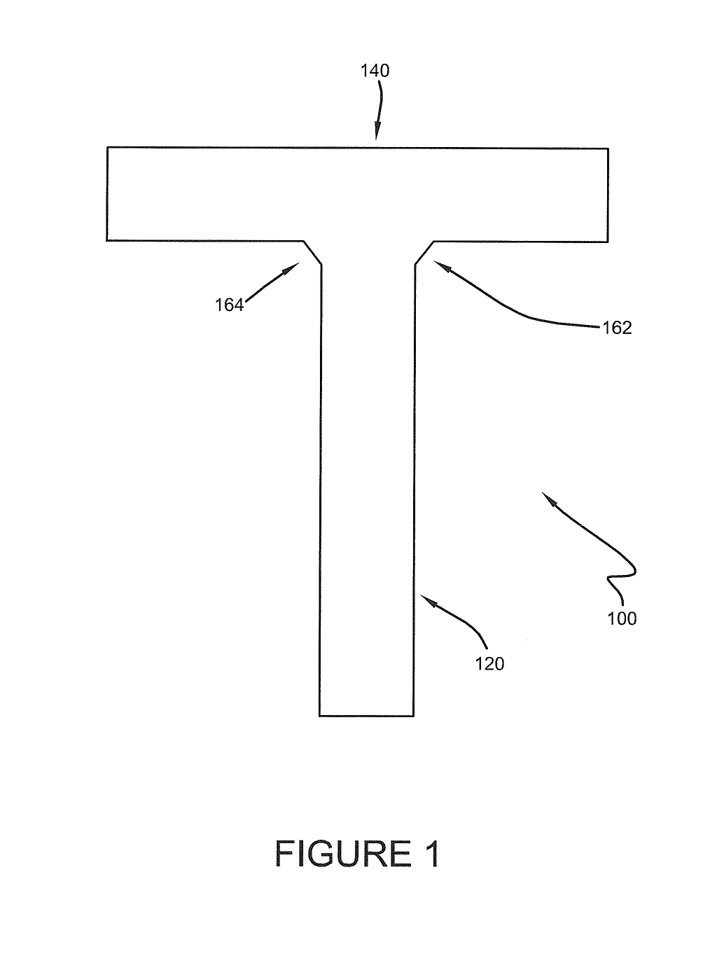

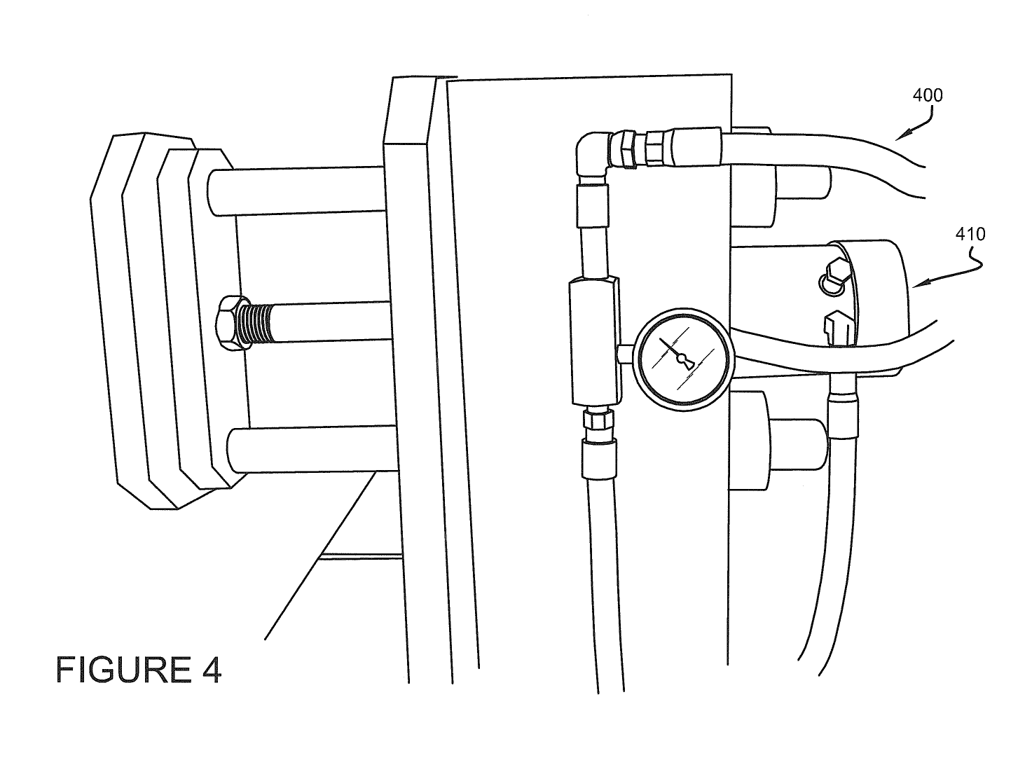

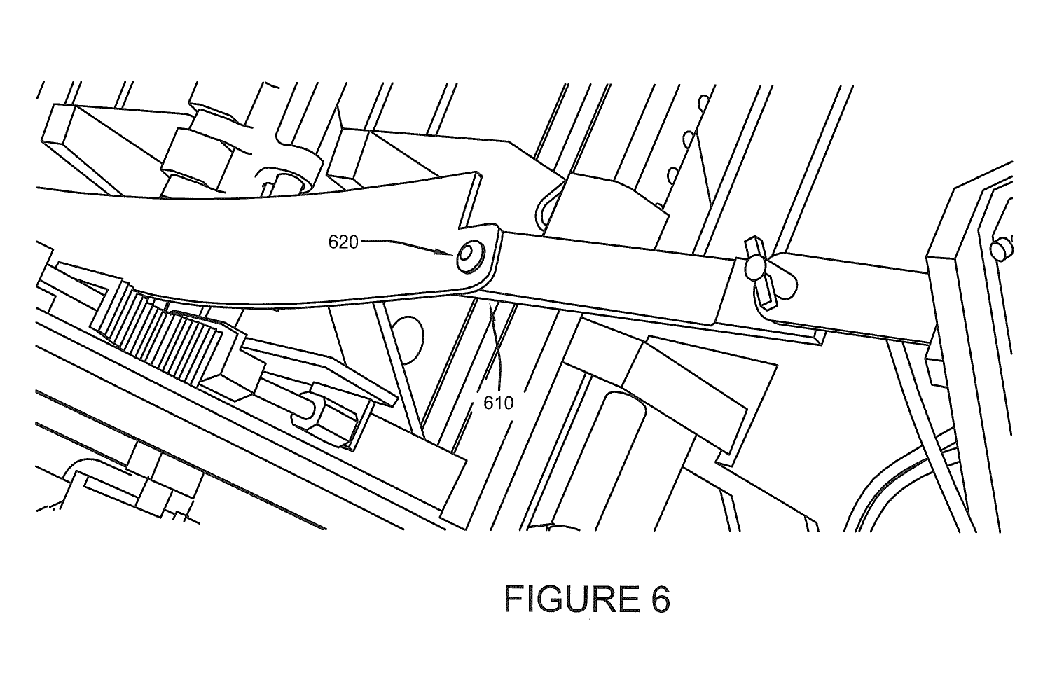

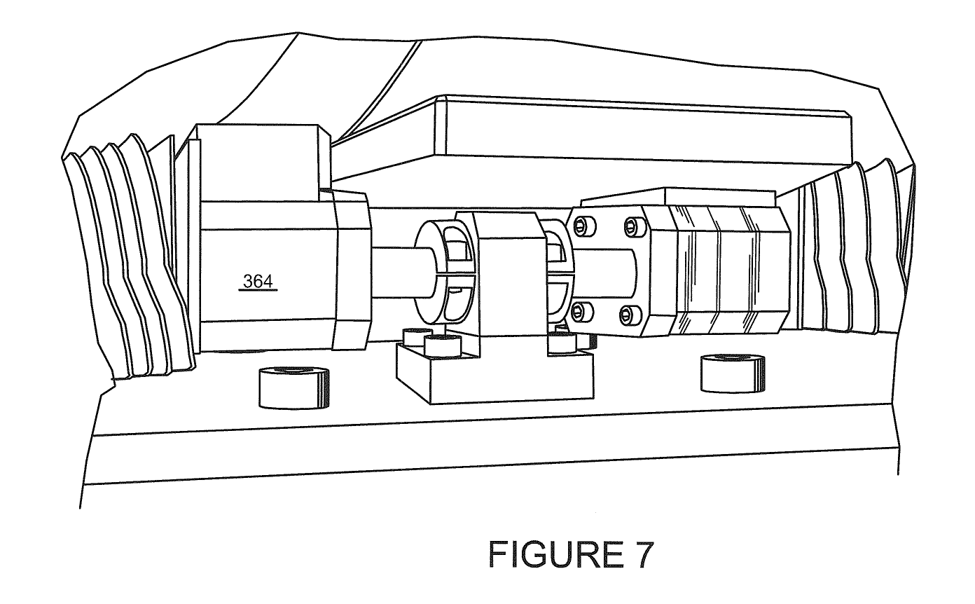

Reference will be made to the drawings, FIGS. 1-9, wherein the showings are only for purposes of illustrating certain embodiments of an apparatus and method for manufacturing a beam, and not for purposes of limiting the same.

As noted above, the form of a structural beam depends, at least in part, on the geometry of the beam and the material of the beam. In some embodiments, a beam may be comprised of multiple beam components joined to form the beam. A beam component may comprise a web or a flange.

Structural beams may comprise I-beams, T-beams, angles, channels, hollow structural sections, and other geometries. The geometry of a beam may also be defined by parameters that may comprise, the length of the beam, the height of the beam, the weight of the beam per unit length, flange width, web thickness, flange thickness, cross-sectional area, and cross-sectional moment of inertia.

Structural beams come in a wide variety of materials. Structural beams may comprise structural materials. Structural materials may comprise steel, stainless steel, iron, iron alloys, aluminum, aluminum alloys, titanium, titanium alloys, nickel, nickel alloys, other metals or metal alloys, composite materials, polymers, wood, concrete, and other materials. Steel may comprise, carbon steels, high strength low alloy steels, corrosion resistant high strength low alloy steels, and quenched and tempered alloy steels.

A structural beam may be formed from multiple beam components. A beam component may be in the form of a plate, a strap, a rod, or another form. In some embodiments, the beam components may comprise a first beam component and a second beam component, where the first beam component comprises a web and the second beam component comprises a flange. In some embodiments the beam components may be elongated beam components. In some embodiments, the beam components may comprise a first beam component and a second beam component, where the first beam component may comprise an elongated web and the second beam component may comprise an elongated flange. A beam component of a beam may comprise any of the above listed structural materials.

Without limitation, FIG. 1 shows a cross-section of a T-beam 100. T-beam 100 may comprise a web 120 and a flange 140. Because the view is a cross-section, the T-beam 100 shown in FIG. 1 has an axis of elongation that is perpendicular to the cross-sectional plane. Stated another way, the T-beam shown in FIG. 1 has an axis of elongation that extends into or out of the page plane. The web 120 and the flange 140 may be elongated components and may have axes of elongation that are perpendicular to the cross-sectional plane. Without limitation, in some embodiments, the axes of elongation of the components of the beam 100 may be all parallel to the axis of elongation of the beam 100. The elongated web 120 and the elongated flange 140 may be joined together to form beam 100 by weld 162 and weld 164.

The beam components 120, 140 may be joined to form the structural beam 100. In certain embodiments, such as, without limitation, that shown in FIG. 1, beam 100 may be formed from a plurality of elongated straps of material, with first beam component 120 forming a web joined to second beam component 140 forming a flange. The processes that may be used to join the components of structural beam 100 may depend upon the material or materials from which the beam components 120, 140 are formed. Processes that may be appropriate to some materials may comprise welding, brazing, soldering, use of adhesives, use of mechanical fasteners, or some combination thereof. For example, and without limitation, steel beam components 120, 140 may be joined by welding to form a steel beam 100.

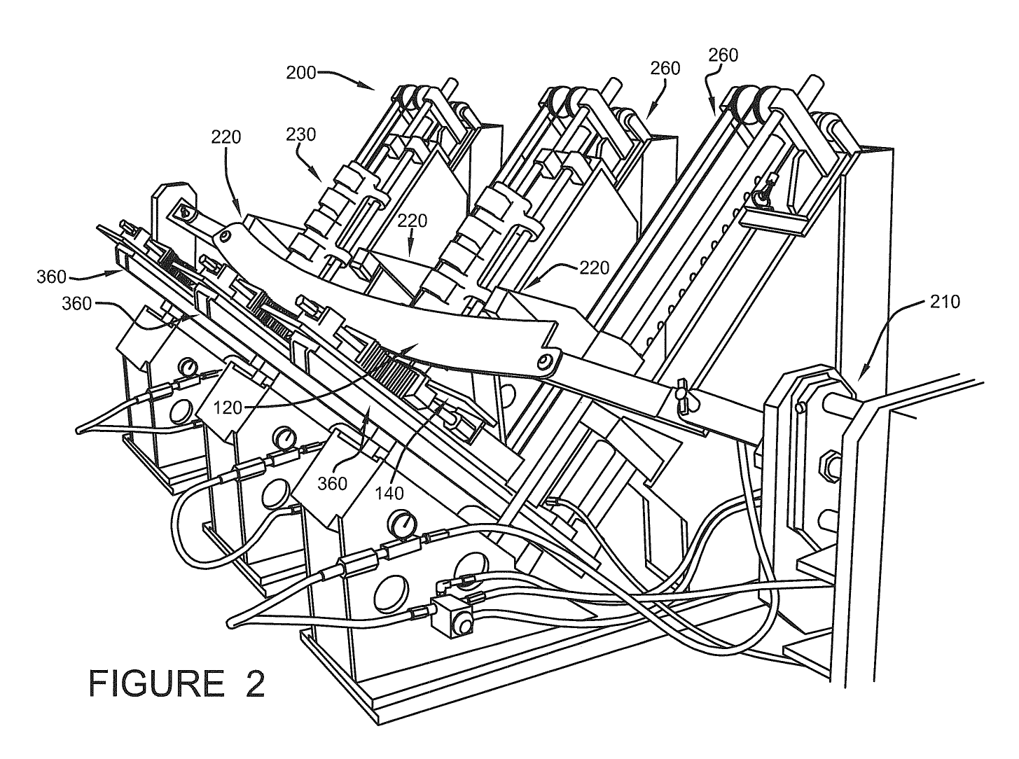

In certain embodiments, and without limitation, a plurality of beam components 120, 140 may be held substantially fixed with respect to one another during a process used to join the beam components 120, 140 into the structural beam 100. In certain embodiments and without limitation, sections of beam components 120, 140 may be held substantially fixed with respect to one another during the process used to join the beam components 120, 140 into the structural beam 100. As shown in FIGS. 2-9 and without limitation, a fixture 200 may hold or secure the entire beam component 120, 140 or a section of a beam component 120, 140 substantially fixed in one or more dimensions. In certain embodiments and without limitation, a section of first beam component 120 may be held substantially fixed with respect to a section of second beam component 140 in one or more dimensions by the fixture 200. In certain embodiments, some portions of the fixture 200 may be free to move with respect to other portions of the fixture 200. In certain embodiments and without limitation, a first section of first beam component 120 may be held substantially fixed with respect to a first section of second beam component 140 in one or more dimensions by a fixture 200, but the fixture 200 may still permit a second section of first beam component 120 to move with respect to a second section of second beam component 140 or may permit a section of first beam component 120 or a section of second beam component 140 to move with respect to the ground, or to move with respect to certain portions of the fixture 200. In certain embodiments and without limitation, a section of first beam component 120 may be held substantially fixed with respect to a section of second beam component 140 in one or more dimensions by a fixture 200, by exerting a compressive force on the section of first beam component 120 and on the section of second beam component 140.

In certain embodiments, and without limitation, a fixture 200 may comprise a tensioner 210, a clamp 220, a slide 370, a location surface 230, or a float system 260.

A tensioner 210 may be any device adapted to apply a tensile force to a beam component 120, 140. In certain embodiments, a tensioner 210 may comprise hydraulic machinery 400, pneumatic machinery, a mechanism or some combination thereof. Hydraulic machinery 400 may comprise a hydraulic cylinder 410, a hydraulic pump, a valve, an actuator, a reservoir, an accumulator, hydraulic fluid, or some combination thereof. Pneumatic machinery may comprise a pneumatic cylinder, a compressor or other pressurized gas source, a valve, an reservoir, bottle, or other gas storage device, a gas, or some combination thereof. A mechanism may comprise, an input link, an output link, an connector link, a linkage, a lever, a pivot, a fulcrum, an axle, a screw, a spring, or some combination thereof.

A tensioner 210 may comprise an adaptation for engagement with a beam component 120, 140. An adaptation for engagement with a beam component 120, 140 may comprise a clamp, a mechanical fastener, a hole adapted to engage a mechanical fastener, or some combination thereof. In some embodiments, and without limitation, as shown in FIG. 2, an adaptation for engagement with a beam component 120 may comprise a pin 610 adapted for engagement with a hole 620 in beam component 120.

In certain embodiments, a tensioner 210 may be adapted to induce substantial strain in a beam component 120, 140. Some beam components 120, 140 may comprise components having a large cross-section, having a high modulus of elasticity, or some combination thereof. In certain embodiments, tensioner 210 may be adapted to induce substantial strain in components having a large cross-section, having a high modulus of elasticity, or some combination thereof. In certain embodiments, tensioner 210 may be adapted to provide forces on the order of multiple millions of Newtons.

A beam component 120, 140 may have a neutral axis. In certain embodiments, the beam component 120, prior to being joined with another component 140 to form the beam 100, may have a free state in which the beam component 120 has a substantially straight neutral axis. As noted above, tensioner 210 may apply a tensile force to the beam component 120. A tensile force, like all forces, may be described by a vector having both magnitude and direction. The direction of application of a tensile force applied to the beam component 120 may be parallel to the neutral axis of the beam component 120, at an angle to the neutral axis of the beam component 120, or skew to the neutral axis of the beam component 120. Without limitation, the direction of application of a tensile force applied to beam component 120 may be parallel to the neutral axis of the beam component 120 and offset from the plane comprising the neutral axis so that application of the tensile force to the beam component 120 induces a force in the beam component 120, and also induces a moment in the beam component 120. As shown in FIG. 2, and without limitation, application of the tensile force in a direction parallel to, and offset below, the neutral axis of beam component 120 induces a moment in beam component 120 that bends the beam components 120 downwards at the middle thereof.

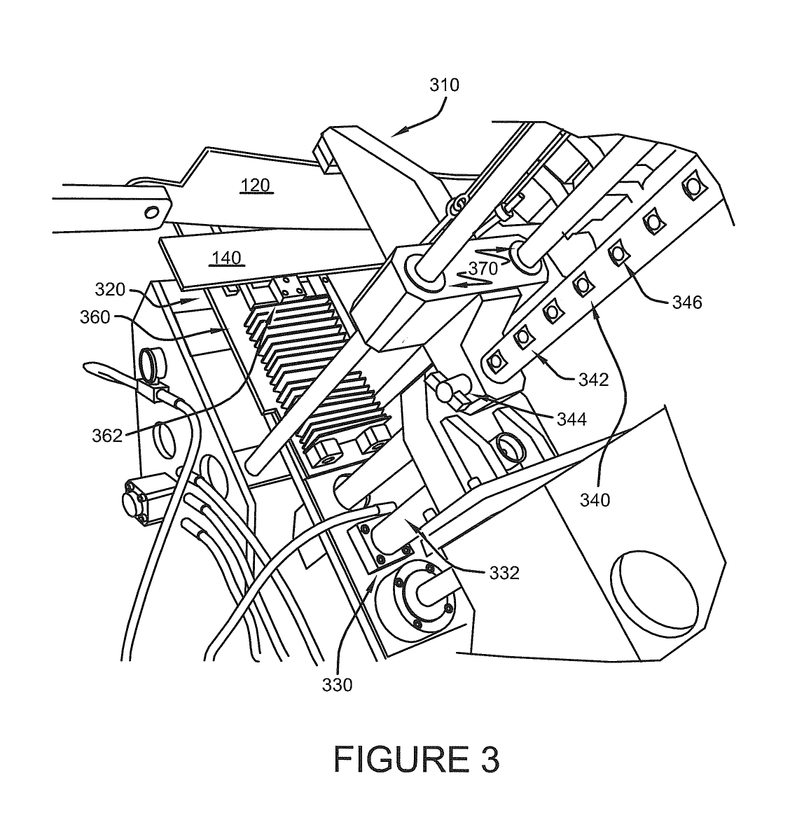

In certain embodiments and without limitation, a section of first beam component 120 may be held substantially fixed with respect to a section of second beam component 140 in one or more dimensions by a fixture 200, by exerting a compressive force on the section of first beam component 120 and on the section of second beam component 140 using a clamp 220. In certain embodiments and without limitation, the clamp 220 may comprise a first end 310 and a second end 320 wherein the first end 310 and the second end 320 may be adapted to apply a compressive force therebetween. In certain embodiments, the clamp 220 may comprise an actuator. An actuator may comprise hydraulic machinery 330, pneumatic machinery, a mechanism, or some combination thereof, adapted to induce a compressive force between the first end 310 and the second end 320. As shown in FIG. 3 and without limitation, in certain embodiments a clamp 220 may comprise a hydraulic cylinder 332 adapted to pull second end 320 of clamp 220 toward first end 310 of clamp 220 and to apply a compressive force to objects, such as, without limitation, a section of first beam component 120 and a section of second beam component 140, located therebetween.

In certain embodiments, a clamp 220 may comprise an actuator having a maximum actuation distance. A maximum actuation distance is the maximum displacement over which actuator is capable of acting. Without limitation, in certain embodiments, as shown in FIG. 3, an actuator may comprise a hydraulic cylinder 332 having a maximum actuation distance defined, at least in part, by the length of the hydraulic cylinder 332.

Clamping distance is the distance between the first end 310 and the second end 320. In certain embodiments, the clamp 220 may comprise a clamping distance that is greater than the maximum actuation distance of the actuator. In certain embodiments, the clamp 220 may comprise an adjustable connection 340 that permits the clamping distance between the first end 310 and the second end 320 to be adjusted. Without limitation, the clamping distance may permit the clamp 220 to accept and clamp together components 120 and 140 that may be taller, wider, or otherwise larger than the maximum actuation distance of the actuator. As shown in FIG. 3, and without limitation, in certain embodiments, an adjustable connection 340 may comprise a pin connector 344 adapted to selectably engage the first end 310 with the second end 320 by any of a plurality of pin receptacle holes 346 in connector 342. In the non-limiting embodiment shown in FIG. 3, each of the plurality of pin receptacle holes 346 in connector 342 corresponds to a different selectable clamping distance amount. Engagement of the first end 310 with the pin 344 to a particular pin receptacle hole 346 selects the clamping distance between the first end 310 and the second end 320 as a particular distance.

In certain embodiments, the clamp 220 may comprise a fastener 360 adapted to hold the component 140 in a fixed position, in one or more dimensions, with respect to at least part of clamp 220. Without limitation, in certain embodiments, the clamp 220 may comprise a fastener 360 adapted to hold the component 140 in a fixed position with respect to the second end 320. In certain embodiments, and without limitation, as shown in FIG. 3, fastener 360 may comprise a secondary clamp. In certain embodiments, fastener 360 may comprise a secondary clamp having a first end 362 and second end 364. In certain embodiments, fastener 360 may comprise a secondary clamp having a first end 362 and second end 364, wherein both ends 362 and 364 are adapted to be moved equally and simultaneously toward or away from a central clamping plane halfway between ends 362 and 364. In certain embodiments, fastener 360 may comprise a secondary clamp comprising a first end 362 engaged with a first mechanical screw having a first handedness or chirality and comprising a second end 364 engaged with a second mechanical screw having a second handedness or chirality opposite that of the first handedness or chirality and wherein both ends 362 and 364 are adapted to be moved equally toward or away from the central clamping plane.

In certain embodiments, the clamp 220 may be engaged with a tensioner 210, another clamp 220, a location surface 230, other portions of a fixture 200, or the ground. In certain embodiments, the clamp 220 may be engaged with a tensioner 210, another clamp 220, a location surface 230, other portions of a fixture 200, or the ground in a manner that permits the clamp to move in one or more dimensions. In certain embodiments, the clamp 220 may be engaged to a tensioner 210, another clamp 220, a location surface 230, other portions of a fixture 200, or the ground with a slide 370.

A slide 370 may comprise a rail, shaft 370, track, mechanism, or other guide that permits the clamp 220 to move in one or more dimensions. In certain embodiments, and without limitation, the slide 370 may be straight or curved. In certain embodiments, and without limitation, as shown in FIGS. 2 and 3, the clamp 220 may be engaged to the shaft 370 in a manner that permits the clamp 220 to move along shaft 370. Without limitation, in certain embodiments, the clamp 220 may be engaged to the elongated shaft 370 in a manner that permits the clamp to move in a dimension parallel to the axis of elongation of the elongated shaft 370. Without limitation, in certain embodiments, the clamp 220 may be engaged to the elongated shaft 370 with a bearing in a manner that permits the clamp 220 to move in a dimension parallel to the axis of elongation of the elongated shaft 370, and wherein the axis of elongation of the shaft is perpendicular to the direction of application of tensile force from the tensioner 210.

Without limitation, in certain embodiments, permitting the clamp 220 to move may allow component 120, 140 or a section of component 120, 140 to move or to be strained while still maintaining engagement with another component 120, 140 clamped thereto. Without limitation, in certain embodiments, permitting the clamp to move can allow component 120 or a section of component 120 to move or be strained, such as, without limitation, by inducing a moment in beam component 120 that bends the beam component 120 downwards at the middle thereof, while still maintaining engagement with another component 140 clamped thereto.

In certain embodiments, the clamp 220 may be engaged with a float system 260. A float system is a system adapted to minimize or eliminate the effects of the weight of the clamp 220 on the clamp 220, on beam components 120, 140, on the beam 100, or on some combination thereof with which the clamp 220 may be engaged. The weight of clamp 220 may act in the vertical downward direction. In certain applications, and without limitation, the weight of the clamp 220 acting on beam component 120, 140 or in the resulting beam 100, may create distortion in the beam component 120, 140 or in the resulting beam 100. In certain applications, and without limitation, the float system 260 may be engaged with the clamp 220 in order to minimize or eliminate the effects of the weight of the clamp 220 in beam component 120, 140 or in the resulting beam 100. The float system 260 may comprise a system adapted to apply forces to the clamp 220 substantially opposite in magnitude and direction to those forces of the weight of the clamp 220. The float system 260 may comprise a counter-weight engaged to the clamp via a pulley system. In certain embodiments, the force acting on the clamp 220 from the float system 260 may be substantially equal to the weight of the clamp 220 and may be substantially opposite in direction to the direction of the force of the weight of the clamp 220. In certain embodiments, the force acting on the clamp 220 from the float system 260 may be substantially equal to the product of the weight of the clamp 220 and the sine of the angle of the direction of application of the force acting on the clamp 220 with respect to the ground. In certain embodiments, and without limitation, as shown in FIG. 3, the force acting on the clamp 220 from the float system 260 may be applied in a dimension parallel to the axis of elongation of an elongated shaft or rail or track 370 along which the clamp 220 may be adapted to move.

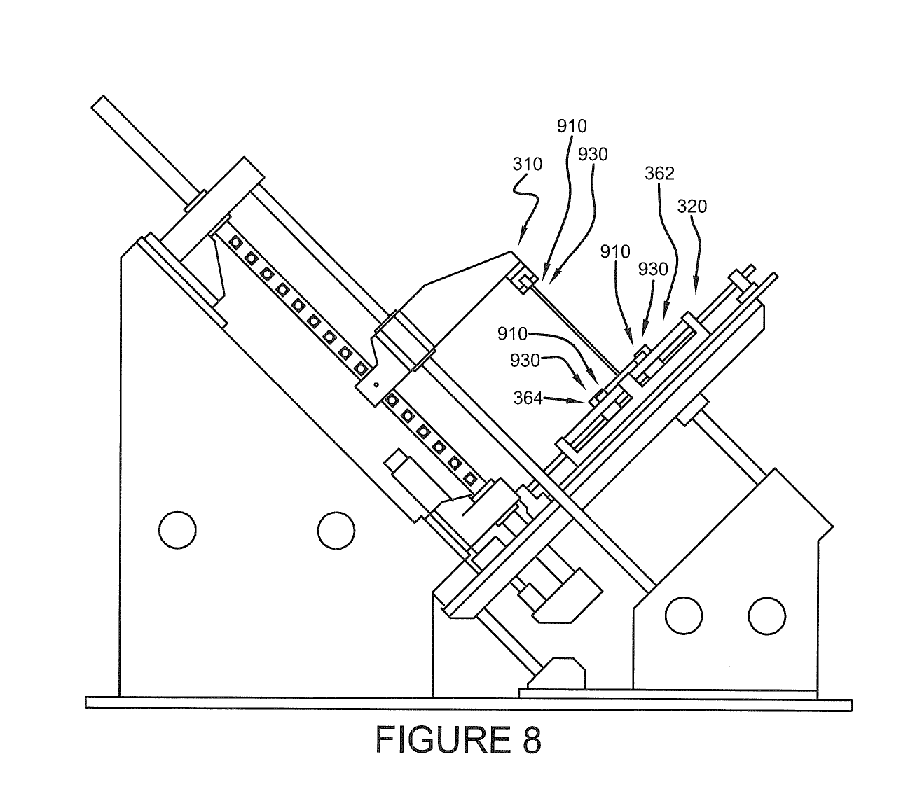

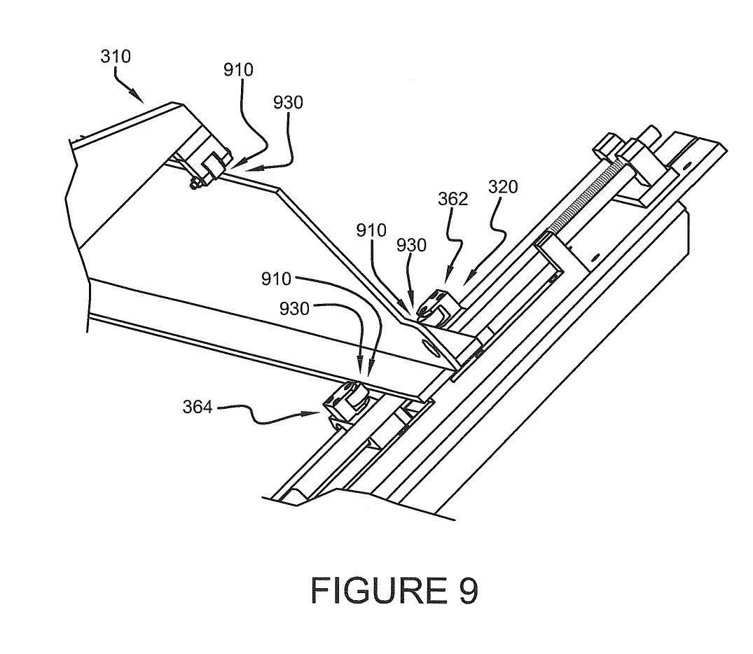

A clamp 220 may engage objects located therebetween with an engagement surface 910. As shown in the FIG. 3, at least one end of clamp 220 may comprise an engagement surface 910. In certain embodiments, and without limitation, as shown in FIG. 3, the first end 310 of clamp 220 may comprise an engagement surface 910 comprising an engagement shoe 920. An engagement shoe 920 may comprise a fixed surface, such as a block or plate, that provides resistance in the form of friction forces to movement parallel to the surface and resistance in the form of normal forces to movement into the surface. In some embodiments, an engagement shoe 920 may comprise a fixed surface that is substantially planar as shown in FIG. 3. In some embodiments, an engagement shoe 920 may comprise a fixed surface that may be curved or comprise grooves, teeth, flanges or other engagement geometries. In certain embodiments, and without limitation, as shown in FIGS. 8 and 9, the first end 310 of clamp 220 may comprise an engagement surface 910 comprising an engagement roller 930. An engagement roller 930 may comprise a rollable surface, such as a roller, bearing, or wheel, that provides resistance, in the form of normal forces to movement into the surface but permits movement by rolling in one or more dimension, and may provide resistance the form of friction forces to movement parallel to the surface in one dimension. Without limitation and as shown in FIG. 9, an engagement roller 930 may roll to allow an object clamped in clamp 200 to move in a dimension perpendicular to the axis along which the clamping force may be applied.

In certain embodiments, a secondary clamp may comprise a first end 362 and second end 364, wherein one or more of first end 362 and second end 364, may comprise an engagement surface 910. As noted above, an engagement surface 910 may comprise an engagement shoe 920 or an engagement roller 930. In certain embodiments, and without limitation, as shown in FIG. 9, the first end 362 of the secondary clamp may comprise an engagement surface 910 comprising an engagement roller 930. Without limitation and as shown in FIGS. 8 and 9, an engagement roller 930 may roll to allow an object clamped in the secondary clamp to move in a dimension perpendicular to the axis along which the clamping force may be applied.

A location surface 230 may be any surface adapted to provide a stop, jam, or other surface, plane, line, or point against which beam component 120, 140 may be placed in order to locate the beam component 120, 140. The location surface 230 may be defined by a plate, a strap, a block, a rod, a shaft, a rail, a beam, or any other object.

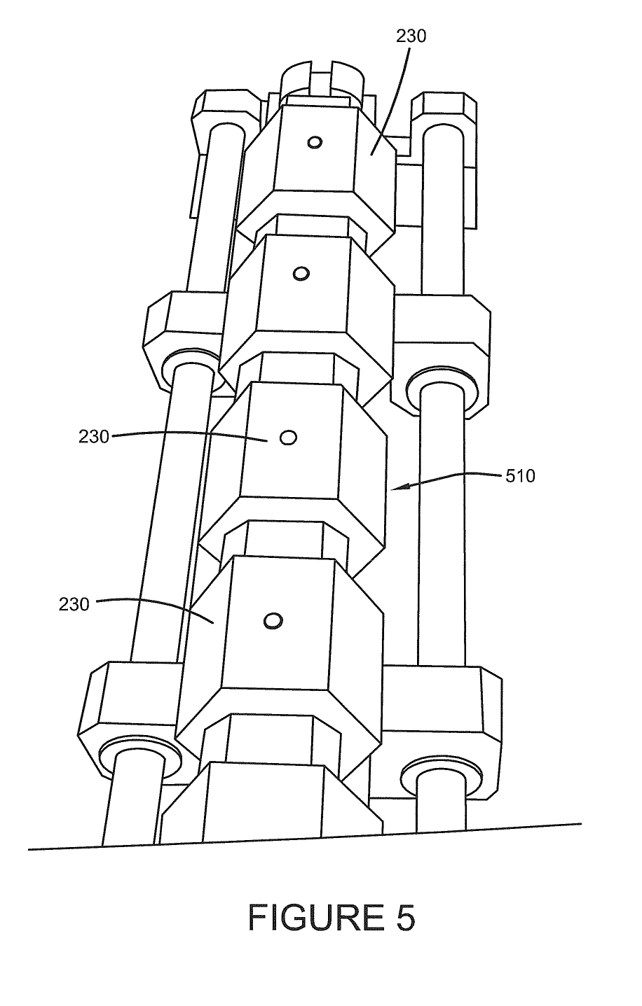

In certain embodiments, and without limitation, as shown in FIG. 5, the location surface 230 may comprise a block 510. In certain embodiments, the block 510 may comprise more than one surface that may act as the location surface 230. In certain embodiments, the block 510 may comprise more than one surface that may act as the location surface 230 and may be rotatable to selectably expose a particular location surface 230. In certain embodiments, and without limitation, as shown in FIG. 5, the block 510 may comprise a hexagonal prism comprising six sides where multiple sides may be adapted to act as the location surface 230. In certain embodiments, and without limitation, as shown in FIG. 5, the block 510 comprises a hexagonal prism comprising six sides where multiple sides may be adapted to act as the location surface 230, and where the block comprises an axis of rotation about which the block 510 may be adapted to rotate. In certain embodiments, and without limitation, as shown in FIG. 5, the block 510 comprises a hexagonal prism comprising six sides where multiple sides may be adapted to act as the location surface 230, and where the block comprises an axis of rotation about which the block 510 may be adapted to rotate, and wherein at least one location surface 230 may be a different distance from the axis than is another location surface 230 so that rotation of the block 510 about the axis permits selection among location surfaces 230 adapted to provide different location positions.

Some joining operations heat or cool beam components 120, 140 during the joining operations. Many materials of which beam components may be formed undergo dimensional changes when heated or cooled. Some joining operations cause beam components subject thereto to undergo dimensional changes or thermal strain. The thermal strain per unit of temperature change of a material during temperature change may be quantified by a coefficient of linear thermal expansion. Without limitation, in many embodiments, the components of the beam 100 expand when heated.

As noted above, welding may be a joining operation. Welding of a component that expands when heated may result in expansion of the component to be joined during the welding process. In some embodiments, and without limitation, with beam components 120, 140 of known geometry and comprising a known material to be joined into beam 100 using a known joining process, it may be possible to make reliable engineering predictions about the behaviors of the beam components 120, 140 during and after the joining operation with respect to dimensional changes or thermal strains to which they may be subject such that compensating measures may be taken with respect to the predicted dimensional changes or thermal strains.

For sake of example, and without limitation, an elongated first beam component 120 and an elongated second beam component 140 may each comprise a steel of known mechanical properties and known geometries. For sake of illustration, and without limitation, for the steel comprising the beam components 120, 140, the coefficient of linear thermal expansion may be approximately, 12×10̂-6 cm/cm per degree C. A 30 foot elongated beam 100 may be formed by welding together a 30 foot elongated first beam component 120 and a 30 foot elongated second beam component 140 with an elongated weld of known properties. For sake of illustration, and without limitation, the welding operation may heat knowable regions of the component to temperatures approximately 1300 degrees C. above the temperatures to which the component will be subjected to during normal use. For sake of illustration, and without limitation, a simple approximation of the dimensional change of beam component 140 in the dimension of elongation during welding may be made by taking the product of the coefficient of linear thermal expansion of the steel of the beam, 12×10̂-6 cm/cm per degree C., the approximate change in temperature, 1300 C, and the total length of the beam component, 30 feet, the thermal strain would be approximately 0.0156 cm/cm, yielding a dimensional change of 0.468 feet or approximately 5.6 inches. Similarly, the dimensional change of beam component 140 in the dimension of elongation subsequent to welding would be a reduction of the thermal strain of approximately 0.0156 cm/cm and a reduction of 0.468 feet over that of it's length during welding. This expected post-welding reduction may, in some situations, result in uneven strain or distortion of the beam unless measures are taken to compensate for this expected post-welding reduction of the thermal strain and reduction of length.

In certain embodiments, means to compensate for post-welding reduction of the thermal strain and reduction of length in one component may comprise preparation of another component to be over-sized in some way. In some embodiments, and without limitation, web 120 may be prepared to be over-sized prior to joining with flange 140. In some embodiments, and without limitation, the web 120 may be prepared to be over-sized prior to joining with the flange 140 such that web 120 forms a curved component with a first edge of web 120 being substantially longer than a second edge of web 120. In some embodiments, and without limitation, the over-sized web 120 may be joined with the flange 140 with a welding operation that causes flange 140 to warm to a temperature substantially above the nominal operating temperature of the beam 100 and to expand as a result of thermal strain. Subsequent to the joining operation, the flange 140 of beam 100 may cool and contract as a result. The contracting flange 140 may exert a compressive stress on the web 120 and the web 120 may exert tensile stress on the contracting flange 140. Careful selection of the geometry, or the material, or both the geometry and the material of the flange 140, or the web 120, or both the flange 140 and the web 120, may result in beam 100 that has the desired dimensions after the beam 100 and the flange 140 and web 120 cool to the nominal operating temperature of the beam 100.

In certain embodiments, means to compensate for expected post-welding thermal contraction may comprise adding strain to first components 120 or a section of first component 120 such that the total strain in the first component 120 may be substantially equal to the thermal strain in the component 140 to which the first component 120 is to be joined. Total strain in any direction in any region of any component may be a combination of thermal strain and applied mechanical strain. In some embodiments, and without limitation, a desired amount of applied mechanical strain may be applied using the tensioner 210 to induce a desired mechanical strain in a section of beam component 120. In certain embodiments and without limitation, a tensioner 210 may be used to induce the desired mechanical strain in a section of beam component 120 by applying a force parallel to the neutral plane of the beam component and offset from the plane comprising the neutral axis. The mechanical strain induced by the tensile force may be calculated as shown in Equation A below:

$${ɛ}_{mech} = \frac{F}{AE} + \frac{F δ y}{IE} \qquad Equation A$$

Wherein:
ε_{mech} is the mechanical strain;
F is the tensile force applied by the tensioner 210;
A is the cross-sectional area of the beam component;
E is the Modulus of Elasticity of the beam component;
δ is the distance by which the plane in which the applied tensile force acts is offset from the neutral axis;
y is the distance from the neutral axis;
I is the moment of inertia of the cross-section of the beam component.

For example, and without limitation, it may be possible to induce a mechanical strain equal to 0.0156 cm/cm in the bottom edge of the beam component 120 shown in FIG. 2. Assuming for the sake of example only, and without limitation that the beam component 120 is 1 cm thick, 20 cm high, and made of a steel having a modulus of elasticity of 200 Gpa, the area of the cross-section is 2.0×10̂-3 m̂2 and the moment of inertia is 6.67×10̂-4 m̂ 4. Applying a force of approximately 6.1×10̂ 6 N along a plane 0.09 m below the neutral axis will induce a mechanical strain approximately equal to 0.0156 cm/cm in the bottom edge of the beam component 120.

In certain embodiments in which strain is added to components or regions of components such that the total strain therein may be substantially equal to the thermal strain of components to which they may be joined, the fixture 200 may be used to secure or hold the beam components 120, 140. The fixture 200 may comprise the tensioner 210 adapted to apply a desired amount of force to induce a desired mechanical strain in a section of beam component 120. In certain embodiments and without limitation, the tensioner 210 may be used to induce a desired mechanical strain in a section of beam component 120 by applying a force that also induces a moment within the beam component 120, causing the beam component 120 to bend. The fixture 200 may comprise the clamp 220 adapted to apply a compressive force to hold a section of first beam component 120 and a section of second beam component 140 substantially fixed with respect to one another in one or more dimensions while still permitting the clamped beam components 120, 140 to move in at least one dimension. In certain embodiments, the clamp 220 may be adapted to permit the clamped beam components 120, 140 to bend in response to the moment induced by the tensioner 210 while still holding the section of first beam component 120 and the section of second beam component 140 substantially fixed with respect to one another.

While the method and apparatus for manufacturing a beam has been described above in connection with the certain embodiments, it is to be understood that other embodiments may be used or modifications and additions may be made to the described embodiments for performing the same function of the method and apparatus for manufacturing a beam without deviating therefrom. Further, the method and apparatus for manufacturing a beam may include embodiments disclosed but not described in exacting detail. Further, all embodiments disclosed are not necessarily in the alternative, as various embodiments may be combined to provide the desired characteristics. Variations can be made by one having ordinary skill in the art without departing from the spirit and scope of the method and apparatus for manufacturing a beam. Therefore, the method and apparatus for manufacturing a beam should not be limited to any single embodiment, but rather construed in breadth and scope in accordance with the recitation of the attached claims.

What is claimed is:

1. An apparatus, comprising:
a tensioner adapted to apply a tensile force along a first dimension;
a first clamp comprising a first end and a second end,
said clamp being adapted to apply a clamping force between said first end and said second end,
at least one of said ends movable with respect to the other;
a first slide adapted to secure said first clamp, such that said first clamp is substantially free to move in a second dimension;
a second clamp comprising a first end and a second end,
said clamp being adapted to apply a clamping force between said first end and said second end,
at least one of said ends movable with respect to the other; and
a second slide adapted to secure said second clamp, such that said second clamp is substantially free to move in said second dimension.

2. The apparatus of claim 1 wherein,
the direction of application of said clamping force between said first end and said second end of said first clamp is substantially parallel to said second dimension; and
the direction of application of said clamping force between said first end and said second end of said second clamp is substantially parallel to said second dimension.

3. The apparatus of claim 2 wherein said second dimension is substantially perpendicular to said first dimension.

4. The apparatus of claim 3 wherein,
said first clamp further comprises a secondary clamp,
said secondary clamp of said first clamp comprising, a first end and a second end,
said secondary clamp of said first clamp being adapted to apply a clamping force between said first end of said secondary clamp of said first clamp and said second end of said secondary clamp of said first clamp, and
at least one of said ends of said secondary clamp of said first clamp movable with respect to the other,
said second clamp further comprises a secondary clamp,
said secondary clamp of said second clamp comprising, a first end and a second end,
said secondary clamp being adapted to apply a clamping force between said first end of said secondary clamp and said second end of said secondary clamp,
at least one of said ends said secondary clamp movable with respect to the other.

5. The apparatus of claim 4,
wherein the direction of application of said clamping force between said first end of said secondary clamp of said first clamp and said second end of said secondary clamp of said first clamp is substantially perpendicular to said second dimension; and
wherein the direction of application of said clamping force between said first end of said secondary clamp of said second clamp and said second end of said secondary clamp of said second clamp is substantially perpendicular to said second dimension.

6. The apparatus of claim 5,
wherein said first clamp is substantially constrained from moving in said first dimension; and
wherein said second clamp is substantially constrained from moving in said first dimension.

7. The apparatus of claim 6,
wherein said first clamp is substantially constrained from moving in a third dimension,
where said third dimension is substantially perpendicular to said first dimension, and
where said third dimension is substantially perpendicular to said second dimension; and
wherein said second clamp is substantially constrained from moving in said third dimension.

8. The apparatus of claim 7,
wherein the direction of application of said clamping force between said first end of said secondary clamp of said first clamp and said second end of said secondary clamp of said first clamp is substantially parallel to said third dimension; and
wherein the direction of application of said clamping force between said first end of said secondary clamp of said second clamp and said second end of said secondary clamp of said second clamp is substantially parallel to said third dimension.

9. The apparatus of claim 8, further comprising a locator surface.

10. The apparatus of claim 9,
wherein said first slide comprises a first elongated rail extending parallel to said second dimension, said first elongated rail being operatively engaged with said first clamp such that said first clamp is substantially free to move along a segment of said first elongated rail; and
wherein said second slide comprises a second elongated rail extending parallel to said second dimension, said second elongated rail being operatively engaged with said second clamp such that said second clamp is substantially free to move along a segment of said second elongated rail.

11. An apparatus, comprising:
a tensioner adapted to apply a tensile force along a first dimension to an associated first beam component;
a first clamp adapted to compressively engage an associated second beam component with said associated first beam component;
a first slide adapted to secure said first clamp, such that said first clamp is substantially free to move in a second dimension;
a second clamp adapted to compressively engage said associated second beam component with said associated first beam component;
a second slide adapted to secure said second clamp, such that said second clamp is substantially free to move in said second dimension.

12. The apparatus of claim 1 wherein,
said first clamp is adapted to compressively engage said associated second beam component with said associated first beam component by application of a clamping force thereto; and
wherein the direction of application of said clamping force is substantially parallel to said second dimension.

13. The apparatus of claim 12, wherein said second dimension is substantially perpendicular to said first dimension.

14. The apparatus of claim 13, wherein said tensile force generates a first moment in said associated first beam component

15. The apparatus of claim 14,
wherein said first clamp is substantially constrained from moving in said first dimension;
wherein said second clamp is substantially constrained from moving in said first dimension;
wherein said first clamp is substantially constrained from moving in a third dimension,
where said third dimension is substantially perpendicular to said first dimension, and
where said third dimension is substantially perpendicular to said second dimension; and
wherein said second clamp is substantially constrained from moving in said third dimension.

16. The apparatus of claim 15,
wherein said first slide comprises a first elongated rail extending parallel to said second dimension, said first elongated rail being operatively engaged with said first clamp such that said first clamp is substantially free to move along a segment of said first elongated rail; and
wherein said second slide comprises a second elongated rail extending parallel to said second dimension, said second elongated rail being operatively engaged with said second clamp such that said second clamp is substantially free to move along a segment of said second elongated rail.

17. The apparatus of claim 16, further comprising a locator surface.

18. The apparatus of claim 17,
wherein said apparatus is adapted to provide clearance for performance of a joining operations to join said first beam component and said second beam component to form a beam;
wherein said joining process induces a second moment in the resulting beam at the nominal operating temperature of said beam; and
wherein said second moment is substantially equal in magnitude to said first moment, and wherein said second moment is substantially opposite in direction from said first moment.

19. A method, comprising:
applying a tensile force along a first dimension to a first beam component;
applying a first compressive force with a first clamp to compressively engage at least part of a second beam component with at least part of said first beam component,
said first clamp being free to move in a second dimension,
said first compressive force being applied in a direction substantially parallel to said second dimension; and
applying a second compressive force with a second clamp to compressively engage at least part of said second beam component with at least part of said first beam component,
said second clamp being free to move in a second dimension,
said second compressive force being applied in a direction substantially parallel to said second dimension.

20. The method of claim 19,
wherein said applied tensile force induces a first moment in said first beam component;
wherein said second dimension is substantially perpendicular to said first dimension;
wherein said first clamp and said second clamp are substantially constrained from moving in said first dimension; and
wherein said first clamp and said second clamp are substantially constrained from moving in a third dimension,
where said third dimension is substantially perpendicular to said first dimension, and
where said third dimension is substantially perpendicular to said second dimension; and
further comprising joining said first beam component and said second beam component to form a beam using a joining process that induces a second moment in the resulting beam at the nominal operating temperature of said beam,
wherein said second moment is substantially equal in magnitude to said first moment, and wherein said second moment is substantially opposite in direction from said first moment.
